(19) United States
(12) Patent Application Publication
(10) Pub. No.: US 2026/0363840 A1
(43) Pub. Date: Nov. 19, 2026

(54) 2-IN-1 WATER FLOSSER AND ELECTRIC TOOTHBRUSH DEVICE

(71) Applicant: Dongguan Huachuang Youpin Electronic Technology Co., Ltd., Dongguan (CN)

(72) Inventors: ANZHEN WANG, Dongguan (CN); HUATAO WU, Dongguan (CN)

(21) Appl. No.: 19/742,216

(22) Filed: Jul. 15, 2026

(30) Foreign Application Priority Data
Oct. 21, 2025 (CN) 202522217716.3
Jul. 9, 2026 (CN) 202621042493.X

(51) Int. Cl. A61C 17/36; A61C 17/34

(52) U.S. Cl. CPC A61C 17/36; A61C 17/3436

(57) ABSTRACT

The invention discloses a 2-in-1 water flosser and electric toothbrush device, comprising a main housing, a top cover and a water tank, wherein water flosser assembly is assembled on one side inside the main housing, and an electric toothbrush assembly is assembled on the other side inside the main housing; a toothbrush switch is arranged on the side of the main housing corresponding to the electric toothbrush assembly, and a water flosser switch is arranged on the side of the main housing corresponding to the water flosser assembly; the top cover is arranged on the top of the main housing and provided with an insertion hole corresponding to the water flosser assembly and a shaft-through hole corresponding to the toothbrush assembly; the detachable water tank is arranged at the lower end of the main housing. The invention integrates the functions of tooth brushing and water flossing.

### CROSS-REFERENCE TO RELATED APPLICATIONS

This application claims priority to Chinese Patent Application No. 202522217716.3, filed on Oct. 21, 2025, and Application No. 202621042493.X, filed on Jul. 9, 2026 which are hereby incorporated by reference in its entirety.

### TECHNICAL FIELD

The invention relates to the technical field of oral care devices, in particular to a 2-in-1 water flosser and electric toothbrush device.

### BACKGROUND

With the increasing awareness of oral health, water flossers and electric toothbrushes have become common oral care tools. Water flossers can use high-pressure water flow to clean areas that are difficult for toothbrushes to reach, such as interdental spaces and gingival sulci, while electric toothbrushes achieve efficient brushing through high-frequency vibration or oscillation. The combined use of both can significantly improve oral cleaning results.

However, existing water flossers and electric toothbrushes are mostly independent products, which have the following deficiencies:

First, they are inconvenient to carry and use. When going out, users need to carry both devices along with their respective chargers and accessories, occupying luggage space. When brushing teeth with the tooth brushing device, an additional rinsing cup is also needed.

Second, the usage cost is high. Purchasing two separate devices requires higher expenses, and separate charging and maintenance also increase the complexity of use.

Third, the degree of functional integration is low, as it is not possible to quickly switch between brushing and flossing functions on the same device, affecting oral care efficiency.

Therefore, there is an urgent need to design a device that integrates the functions of a water flosser and an electric toothbrush to address the above problems.

### SUMMARY

The invention aims to overcome the defects of inconvenient carrying and use, high usage cost, and low functional integration caused by the separate arrangement of water flossers and electric toothbrushes in the prior art, and to provide a 2-in-1 water flosser and electric toothbrush device.

To achieve the above objectives, the invention adopts the following technical solution:

A 2-in-1 water flosser and electric toothbrush device comprises a main housing, a top cover and a water tank, wherein water flosser assembly is assembled on one side inside the main housing, and an electric toothbrush assembly is assembled on the other side inside the main housing; a toothbrush switch is arranged on the side of the main housing corresponding to the electric toothbrush assembly, and a water flosser switch is arranged on the side of the main housing corresponding to the water flosser assembly; the top cover is arranged on the top of the main housing and provided with an insertion hole corresponding to the water flosser assembly and a shaft-through hole corresponding to the toothbrush assembly; the detachable water tank is arranged at the lower end of the main housing.

Further, the 2-in-1 water flosser and electric toothbrush device further comprises a waterproof plug; positioning holes are further provided on the top cover; a plug block and a connecting block respectively matching the insertion hole and the positioning hole are arranged on the bottom surface of the waterproof plug; the connecting block is rotatably engaged in the positioning hole; the plug block is configured for detachable insertion and removal in the insertion hole.

Further, a bottom cover is further arranged at the bottom of the main housing; the water tank has an opening at an upper end, is slidably sleeved over the surface of the main housing from bottom to top and is detachably connected to the main housing; positioning clamping blocks are respectively arranged on both sides of an inner wall of the upper end of the water tank; positioning clamping grooves detachably clamped with the positioning clamping blocks are respectively provided on both sides of an outer wall of the upper end of the main housing and on both sides of an outer wall of the lower end of the main housing.

Further, an outer decorative cover protruding outward on all sides is arranged at the upper end of the main housing; the lower end of the outer decorative cover matches the upper end of the water tank and is configured to limit the water tank.

Further, a water filling port connected with the interior of the water tank is arranged on a side wall of the lower end of the water tank; a water filling cover is arranged at the water filling port; one side of the water filling cover is hinged to a buckle on the side wall of the water tank in a flip-open manner, and an inlet and outlet plug detachably clamped with the water filling port is arranged at the other side of the water filling cover.

Further, a main unit sealing ring is arranged between an outer peripheral wall of the bottom cover and an inner wall of the main housing; a water tank sealing ring is further arranged between the outer peripheral wall of the bottom cover and the inner wall of the water tank.

Further, the water flosser assembly comprises a water flosser pump arranged on one side inside the main housing; a water flosser circuit board electrically connected to the water flosser pump is installed on one side of the water flosser pump; a water flosser encapsulated display unit is arranged on the main housing located on the side of the water flosser circuit board; a water flosser switch is assembled on the water flosser encapsulated display unit at a position corresponding to the starting position of the water flosser circuit board; a pump top ring is assembled on the top of the water flosser pump; a nozzle button is arranged inside the outer decorative cover above the pump top ring and passes through one side of the outer decorative cover in a depressible way; a nozzle is inserted into the insertion hole of the top cover; a clamping slot located on an outer wall of a bottom end of the nozzle forms a snap fit with the nozzle button; a pipe opening at the bottom end of the nozzle forms a sealed plug-in connection with the inner wall of the pump top ring; the bottom end of the nozzle is further connected to the water flosser pump; a through column respectively connected with the main housing and the water tank is arranged inside the bottom cover; one end of a pump connecting pipe is connected to one side of the water flosser pump, and the other end of the pump connecting pipe is sleeved over the top of the through column of the bottom cover; one end of a water tank suction pipe is sleeved over the bottom of the through column, and the other end of the water tank suction pipe extends into the water tank; the water flosser pump is capable of drawing water from the water tank through the pump connecting pipe and the water tank suction pipe, and delivering water to the nozzle; the water tank suction pipe is flexible.

Further, a return spring is arranged between the nozzle button and the main housing, and two ends of the return spring elastically abut against the nozzle button and the inner wall of the main housing.

Further, the electric toothbrush assembly comprises a toothbrush movement arranged on the other side inside the main housing; an electric toothbrush circuit board is installed on one side of the top of the toothbrush movement; a toothbrush switch is assembled on the main housing at a position corresponding to the starting position of the electric toothbrush circuit board; a sonic motor is assembled on the top of the toothbrush movement and is electrically connected to the electric toothbrush circuit board; an upper motor damping rubber, a motor fixing ring and a waterproof motor cover are sequentially arranged between the sonic motor and the top cover from bottom to top; the waterproof motor cover passes through the shaft-through hole of the top cover; a swing shaft is drivingly connected to the top of the sonic motor, passes through the upper motor damping rubber, the motor fixing ring and the waterproof motor cover, and extends above the top cover; a detachable toothbrush head is sleeved over the top of the swing shaft; a battery serving as a power supply is assembled inside the toothbrush movement.

Further, a soft rubber pad is further arranged between the sonic motor and the electric toothbrush circuit board.

Further, a charging interface electrically connected to the battery is further assembled on the surface of the main housing; a detachable flexible charging plug is further arranged at the charging interface, and a plug strip rotatably inserted into a jack socket of the main housing is arranged on one side of the charging plug.

The invention has the following beneficial effects:

The invention integrates the water flosser assembly and the electric toothbrush assembly into a device, achieving the integration of tooth brushing and water flossing functions. Its compact volume facilitates user portability and saves carrying space, while meeting the user's needs for both tooth brushing and water flossing, effectively improving oral care efficiency. Moreover, the separate functions are safer and more stable, and the independently corresponding operation switch buttons are simpler and more user-friendly.

The water flosser assembly and the electric toothbrush assembly of the invention are controlled by corresponding independent switches, allowing the water flossing or tooth brushing functions to be used independently as needed, with flexible switching and improved usage efficiency.

After the waterproof plug is provided in the invention, the plug block of the waterproof plug can be fittingly inserted into the insertion hole, so that after the nozzle is removed, liquid is prevented from entering the interior of the main housing through the insertion hole when the user is brushing teeth. In other words, the waterproof plug can effectively block liquid or dust from entering the interior of the main housing through the insertion hole.

In the invention, the vertically retractable and detachable water tank is arranged. After the water tank is retracted upward (i.e., after the lower end of the main housing is inserted into the water tank), the overall volume of the water flossing and tooth brushing device is effectively reduced, facilitating portability and storage, and making it very suitable for travel. Moreover, after the water tank is removed, it can be used as a rinsing cup for tooth brushing, which improves user convenience, has good practical value, and reduces usage costs. At the same time, the water tank is provided with a water filling port and a water filling cover matching the water filling port, so that water can be conveniently filled into and poured out of the water tank without removing the water tank.

### BRIEF DESCRIPTION OF THE DRAWINGS

FIG. 1 is a first overall structural view of the invention;

FIG. 2 is a second overall structural view of the invention;

FIG. 3 is a third overall structural view of the invention;

FIG. 4 is a schematic view of the invention with a toothbrush head installed;

FIG. 5 is a schematic view of the invention with a nozzle installed;

FIG. 6 is a schematic view of the invention with the toothbrush head and nozzle removed.

### REFERENCE SIGNS

1. Main housing; 101. Positioning clamping groove; 102. Charging interface; 103. Outer decorative cover; 2. Top cover; 21. Insertion hole; 22. Shaft-through hole; 23. Positioning hole; 3. Water tank; 31. Positioning clamping block; 32. Water filling cover; 4. Water flosser assembly; 41. Water flosser pump; 42. Water flosser circuit board; 43. Water flosser encapsulated display unit; 44. Pump top ring; 45. Nozzle button; 46. Nozzle; 5. Electric toothbrush assembly; 51. Toothbrush movement; 52. Electric toothbrush circuit board; 53. Sonic motor; 531. Swing shaft; 54. Upper motor damping rubber; 55. Motor fixing ring; 56. Waterproof motor cover; 57. Toothbrush head; 6. Toothbrush switch; 7. Water flosser switch; 8. Waterproof plug; 81. Plug block; 82. Connecting block; 9. Bottom cover; 91. Through column; 10. Pump connecting pipe; 11. Water tank suction pipe; 12. Return spring; 13. Soft rubber pad; 14. Charging plug; 141. Plug strip.

### DESCRIPTION OF EMBODIMENTS

The invention is further described below with reference to the drawings and specific embodiments. The following description is merely illustrative and does not limit the scope of protection of the invention.

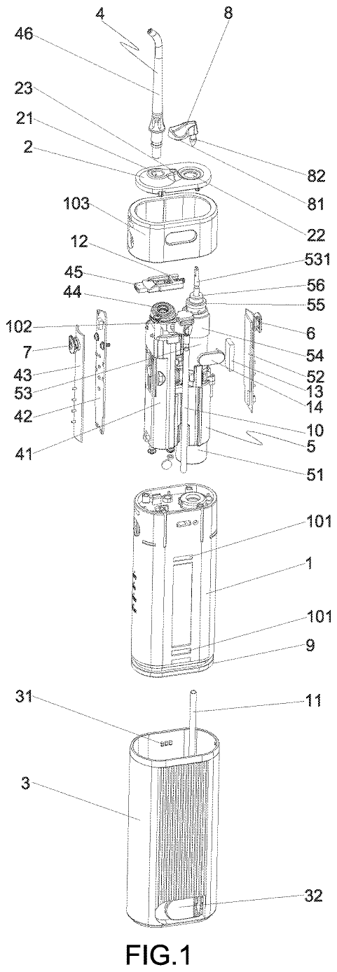

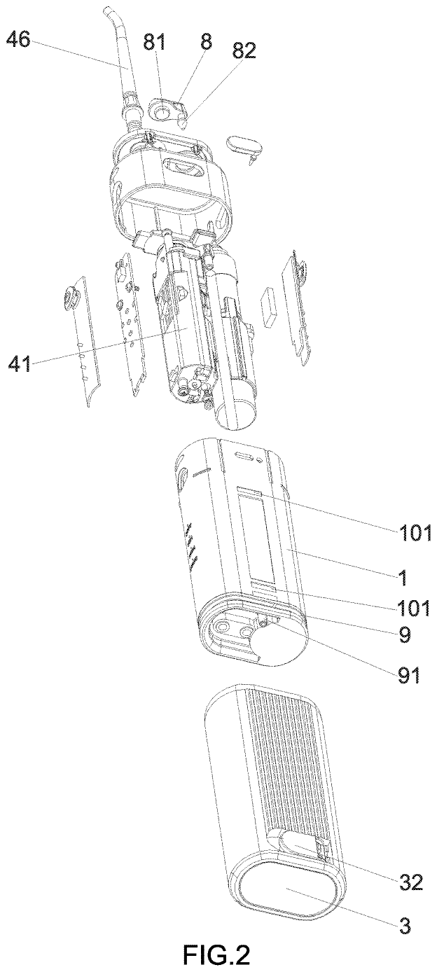

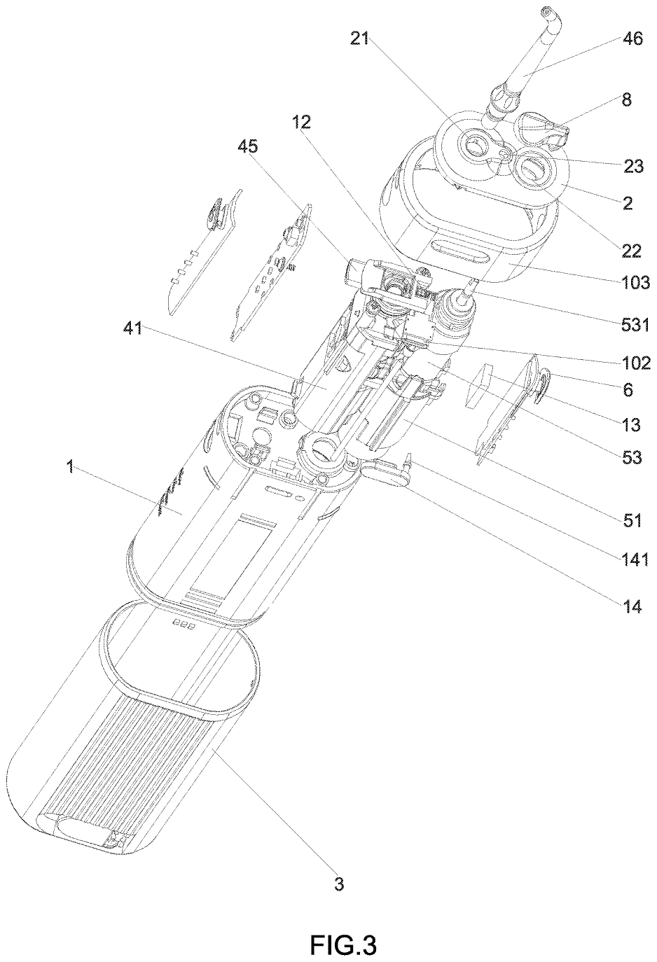

As shown in FIGS. 1-3, a 2-in-1 water flosser and electric toothbrush device comprises a main housing 1, a top cover 2 and a water tank 3, wherein a water flosser assembly 4 is assembled on one side inside the main housing 1, and an electric toothbrush assembly 5 is assembled on the other side inside the main housing 1. Therefore, the water flosser assembly 4 can be used to achieve the water flossing function, and the electric toothbrush assembly 5 can be used to achieve the tooth brushing function. The electric toothbrush assembly 5 and the water flosser assembly 4 form an integrated structure, thereby achieving a partitioned layout of the water flossing and tooth brushing functions; the structure is compact, facilitating the user to carry when going out.

A toothbrush switch 6 is arranged on the side of the main housing 1 corresponding to the electric toothbrush assembly 5, and a water flosser switch 7 is arranged on the side of the main housing 1 corresponding to the water flosser assembly 4, thereby facilitating independent control of the start and stop of the water flossing and tooth brushing functions by the user; a top cover 2 is provided on the top of the main housing 1, and the top cover 2 is provided with an insertion hole 21 corresponding to the water flosser assembly 4 and a shaft-through hole 22 corresponding to the toothbrush assembly; a detachable water tank 3 is arranged at the lower end of the main housing 1 for quick installation and removal. Specifically, the water tank 3 is made of transparent PP material to facilitate user observation of the remaining water level.

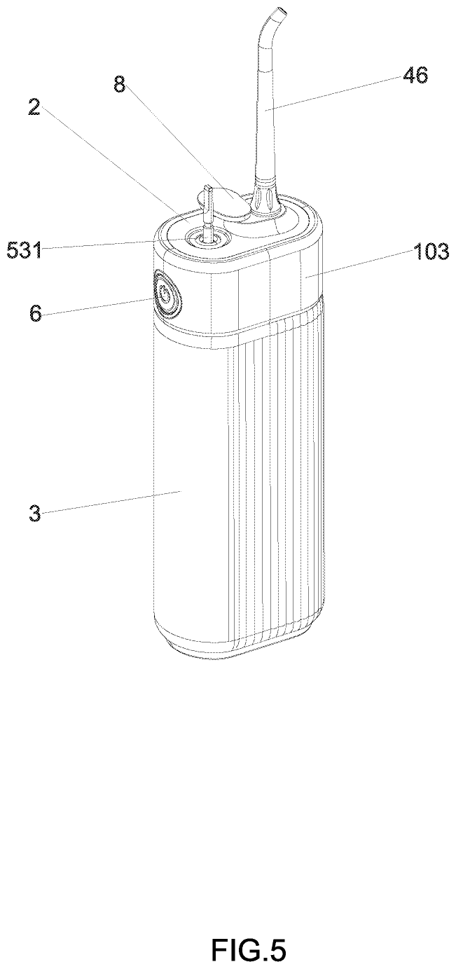

In this embodiment, the device further comprises a waterproof plug 8; a positioning hole 23 is further provided on the top cover 2; a plug block 81 and a connecting block 82 respectively matching the insertion hole 21 and the positioning hole 23 are arranged on the bottom surface of the waterproof plug 8; the connecting block 82 is rotatably clamped in the positioning hole 23; the plug block 81 is used for detachable insertion and removal in the insertion hole 21. Specifically, the waterproof plug 8 is made of soft silicone. After the waterproof plug 8 is arranged, the plug block 81 of the waterproof plug 8 can be fittingly inserted into the insertion hole 21, so that when the user is brushing teeth or when the device is not in use, liquid is prevented from entering the interior of the main housing 1 through the insertion hole 21. In other words, the waterproof plug 8 can effectively block liquid or dust from entering the interior of the main housing 1 through the insertion hole 21. In addition, after the connecting block 82 is clamped in the positioning hole 23, and the plug block 81 is pulled out of the insertion hole 21, the entire waterproof plug 8 can be rotated to one side to misalign the plug block 81 from the insertion hole 21, thereby allowing other components to be inserted into the insertion hole 21 without removing the entire waterproof plug 8 from the top cover 2, as shown in FIG. 5.

A bottom cover 9 is further arranged at the bottom of the main housing 1; the water tank 3 has an opening at the upper end, and the water tank 3 is slidably sleeved over the surface of the main housing 1 from bottom to top and is detachably connected to the main housing 1; positioning clamping blocks 31 are respectively arranged on both sides of the inner wall of the upper end of the water tank 3; positioning clamping grooves 101 detachably clamped with the positioning clamping blocks 31 are respectively provided on both sides of the outer wall of the upper end of the main housing 1 and on both sides of the outer wall of the lower end of the main housing 1. Specifically, to facilitate assembly and disassembly of the water tank 3, the upper and lower sides of both the positioning clamping blocks 31 and the positioning clamping grooves 101 may be correspondingly configured as inclined surfaces. Therefore, after the vertically retractable water tank 3 arranged is retracted upward (i.e., after the lower end of the main housing 1 is inserted into the water tank 3), the overall volume of the water flossing and tooth brushing device is effectively reduced, facilitating portability and storage, and making it very suitable for travel. At the same time, the water tank 3 can also be used by directly pulling out, so that the water tank 3 can be used as a rinsing cup for tooth brushing. Furthermore, the detachable fit between the positioning clamping blocks 31 and the positioning clamping grooves 101 can be used to conveniently position and detach the water tank 3 on the main housing 1. Of course, when the main housing 1 needs to be retracted into the water tank 3, the water tank 3 can be pushed upward directly to disengage the positioning clamping blocks 31 from the lower positioning clamping grooves 101, and then the main housing 1 can be inserted into the water tank 3 until the upper positioning clamping grooves 101 engage with the positioning clamping blocks 31. To remove the water tank 3, it can be pulled outward until the positioning clamping blocks 31 are disengaged from both the upper and lower positioning clamping grooves 101, making it convenient to use.

An outer decorative cover 103 protruding outward on all sides is arranged at the upper end of the main housing 1; the lower end of the outer decorative cover 103 matches the upper end of the water tank 3 and is configured to limit the water tank 3. Therefore, when the water tank 3 is moved upward to a predetermined position, the outer decorative cover 103 arranged can be used to block the water tank 3, thereby serving a limiting function to prevent the water tank 3 from exceeding the preset stroke during movement.

A water filling port (not shown due to visual obstruction) connected with the interior of the water tank 3 is arranged on a side wall of the lower end of the water tank; a water filling cover 32 is arranged at the water filling port; one side of the water filling cover 32 is hinged to a buckle (not marked in the figure) on the side wall of the water tank 3 in a flip-open manner, and an inlet and outlet plug (not shown due to visual obstruction) detachably clamped with the water filling port is arranged at the other side of the water filling cover 32. The water filling port facilitates quick and convenient filling of water into the water tank 3, and also facilitates water pouring out of the water tank 3 without the need to remove the entire water tank 3. Therefore, the inlet and outlet plug of the water filling cover 32 facilitates the closing or opening of the water filling port.

A main housing sealing ring (not shown in the figures) is arranged between the outer peripheral wall of the bottom cover 9 and the inner wall of the main housing 1, thereby improving the sealing performance between the bottom cover 9 and the main housing 1, enhancing waterproof performance, preventing external dust and liquid from entering the interior of the main housing 1, protecting the components inside the main housing 1, and extending the service life of the device; a water tank sealing ring (not shown in the figures) is further arranged between the outer peripheral wall of the bottom cover 9 and the inner wall of the water tank 3, thereby improving the waterproof performance between the bottom cover 9 and the water tank 3 and preventing water leakage from the water tank 3.

The water flosser assembly 4 comprises a water flosser pump 41 arranged on one side inside the main housing 1; a water flosser circuit board 42 electrically connected to the water flosser pump 41 is installed on one side of the water flosser pump 41; a water flosser encapsulated display unit 43 is arranged on the main housing 1 located on the side of the water flosser circuit board 42; a water flosser switch 7 is assembled on the water flosser encapsulated display unit 43 at a position corresponding to the starting position of the water flosser circuit board 42; furthermore, light-transmitting holes may also be provided on the water flosser encapsulated display unit 43, so that the light from an indicator light on the water flosser circuit board 42 can pass through the water flosser encapsulated display unit 43 to display the flushing intensity of the water flosser assembly, facilitating user to view the working status of the water flosser assembly. Furthermore, a pump sealing ring (not marked in the figures) may also be arranged between the water flosser pump 41 and the main housing 1 to improve waterproof performance.

A pump top ring 44 is assembled on the top of the water flosser pump 41; a nozzle button 45 is arranged inside the outer decorative cover 103 above the pump top ring 44 and passes through one side of the outer decorative cover 103 in a depressible way; a nozzle 46 is inserted into the insertion hole 21 of the top cover 2; a clamping slot located on an outer wall of a bottom end of the nozzle 46 forms a snap fit with the nozzle button 45; a pipe opening at the bottom end of the nozzle 46 forms a sealed plug-in connection (seamless plug-in connection) with the inner wall of the pump top ring 44; the bottom end of the nozzle 46 is further connected to the water flosser pump 41; a return spring 12 is arranged between the nozzle button 45 and the main housing 1, and two ends of the return spring 12 elastically abut against the nozzle button 45 and the inner wall of the main housing 1. The nozzle 46 can be quickly inserted and removed through the nozzle button 45, and the pump top ring 54 can effectively prevent the nozzle 46 from leaking during operation.

A through column 91 respectively connected with the main housing 1 and the water tank 3 is arranged inside the bottom cover 9; one end of a pump connecting pipe 10 is connected to one side of the water flosser pump 41, and the other end of the pump connecting pipe 10 is sleeved over the top of the through column 91 of the bottom cover 9; one end of a water tank suction pipe 11 is sleeved over the bottom of the through column 91, and the other end of the water tank suction pipe 11 extends into the water tank 3; the water flosser pump 41 is capable of drawing water from the water tank 3 through the pump connecting pipe 10 and the water tank suction pipe 11, and delivering the water to the nozzle 46; the water tank suction pipe 11 is made of soft silicone, so that when the main housing 1 is retracted into the water tank 3, the water tank suction pipe 11 can bend inside the water tank 3, avoiding affecting the normal entry of the main housing 1. The water flosser pump 41 can generate negative pressure in the water tank 3 through the pump connecting pipe 10 and the water tank suction pipe 11 to draw water, and the water flows through the water tank suction pipe 11, the pump connecting pipe 10, and the water flosser pump 41, and finally is sprayed out of the nozzle 46, achieving the water flossing function. Since this function is prior art, it will not be further described in detail here.

The electric toothbrush assembly 5 comprises a toothbrush movement 51 arranged on the other side inside the main housing 1; an electric toothbrush circuit board 52 is installed on one side of the top of the toothbrush movement 51; a toothbrush switch 6 is assembled on the main housing 1 at a position corresponding to the starting position of the electric toothbrush circuit board 52.

A sonic motor 53 is assembled on the top of the toothbrush movement 51 and is electrically connected to the electric toothbrush circuit board 52; an upper motor damping rubber 54, a motor fixing ring 55 and a waterproof motor cover 56 are sequentially arranged between the sonic motor 53 and the top cover 2 from bottom to top; the waterproof motor cover 56 passes through the shaft-through hole 22 of the top cover 2; a swing shaft 531 is drivingly connected to the top of the sonic motor 53, passes through the upper motor damping rubber 54, the motor fixing ring 55 and the waterproof motor cover 56, and extends above the top cover 2; a detachable toothbrush head 57 is sleeved over the top of the swing shaft 531, facilitating replacement of the toothbrush head 57 by the user and providing certain practicality.

Specifically, the upper motor damping rubber 54 is sleeved over the top end of the sonic motor 53; the motor fixing ring 55 is sleeved over the connection between the sonic motor 53 and the swing shaft 531; the waterproof motor cover 56 is sleeved over the top of the motor fixing ring 55 and forms a waterproof seal with the shaft-through hole 22 of the top cover 2, effectively preventing water penetration during operation of the sonic motor 53 and protecting the internal components of the main housing 1.

A battery (not shown in the figures) serving as a power supply is assembled inside the toothbrush movement 51, wherein the battery is electrically connected to both the water flosser circuit board 42 and the electric toothbrush circuit board 52, thereby effectively providing power to the water flosser assembly 4 and the electric toothbrush assembly 5.

A charging interface 102 electrically connected to the battery is further assembled on the surface of the main housing 1, so that the charging interface 102 can be used to charge the battery. Specifically, a detachable flexible charging plug 14 is further arranged at the charging interface 102, and a plug strip 141 rotatably inserted into a jack socket (not shown in the figures) of the main housing 1 is arranged on one side of the charging plug 14. The charging plug 14 may be made of soft silicone. The charging plug 14 can be used to plug the charging interface 102 when not in use, preventing liquid from entering the charging interface 102 and causing damage. Moreover, by providing the plug strip 141, the charging plug 14 can rotate freely after being removed from the charging interface 102 and be misaligned from the charging interface 102, so that the user can use the charging interface 102 normally without completely separating the charging plug 14, making it very convenient to use.

A soft rubber pad 13 is further arranged between the sonic motor 53 and the electric toothbrush circuit board 52. Specifically, the soft rubber pad 13 is made of silicone material, which can effectively reduce the vibration and operating noise of the sonic motor 53, providing a damping and noise-reducing effect.

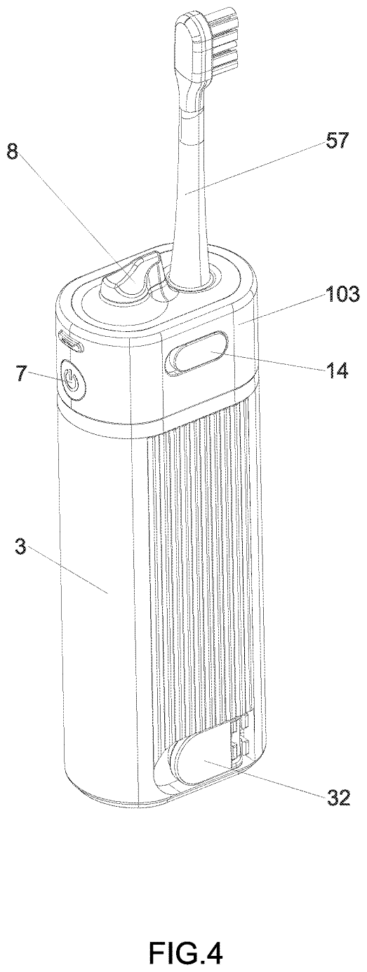

As shown in FIG. 4, when using the 2-in-1 water flosser and electric toothbrush device of this embodiment and needing to brush teeth, the user presses the toothbrush switch 6, and the electric toothbrush circuit board 52 controls the sonic motor 53 to start, driving the swing shaft 531 and the toothbrush head 57 to oscillate at high frequency. The water tank 3 can be detached outward to serve as a rinsing cup for tooth brushing, thereby achieving the tooth brushing function.

As shown in FIG. 5, if water flossing is needed, the user opens the water filling cover 32, fills the water tank 3 with water and presses the water flosser switch 7, the water flosser circuit board 42 controls the water flosser pump 41 to draw water from the water tank 3, pressurize and spray water out of the nozzle 46, thereby achieving the water flossing function.

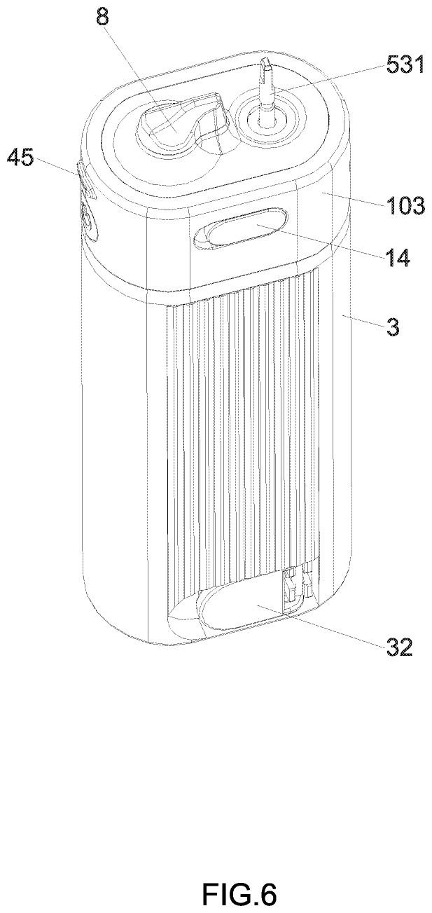

As shown in FIG. 6, after use, the nozzle button 45 can be pressed to remove the nozzle 46 for cleaning, and the toothbrush head 57 can also be replaced, thereby being convenient to operate. At the same time, the waterproof plug 81 can be used to seal the insertion hole 21 to prevent dust, liquid and the like from entering.

The tooth brushing function and the water flossing function of the invention can be used independently, facilitating user needs and user experience.

The invention is not limited to the above embodiments. If various modifications or variations of the invention do not depart from the spirit and scope of the invention, and if such modifications and variations fall within the scope of the claims of the invention and their equivalents, the invention will be also intended to include such modifications and variations.

What is claimed is:

1. A 2-in-1 water flosser and electric toothbrush device, comprising a main housing, a top cover and a water tank, wherein water flosser assembly is assembled on one side inside the main housing, and an electric toothbrush assembly is assembled on the other side inside the main housing; a toothbrush switch is arranged on the side of the main housing corresponding to the electric toothbrush assembly, and a water flosser switch is arranged on the side of the main housing corresponding to the water flosser assembly; the top cover is arranged on the top of the main housing and provided with an insertion hole corresponding to the water flosser assembly and a shaft-through hole corresponding to the toothbrush assembly; the detachable water tank is arranged at the lower end of the main housing.

2. The 2-in-1 water flosser and electric toothbrush device according to claim 1, further comprising a waterproof plug; positioning holes are further provided on the top cover; a plug block and a connecting block respectively matching the insertion hole and the positioning hole are arranged on the bottom surface of the waterproof plug; the connecting block is rotatably engaged in the positioning hole; the plug block is configured for detachable insertion and removal in the insertion hole.

3. The 2-in-1 water flosser and electric toothbrush device according to claim 1, wherein a bottom cover is further arranged at the bottom of the main housing; the water tank has an opening at an upper end, is slidably sleeved over the surface of the main housing from bottom to top and is detachably connected to the main housing; positioning clamping blocks are respectively arranged on both sides of an inner wall of the upper end of the water tank; positioning clamping grooves detachably clamped with the positioning clamping blocks are respectively provided on both sides of an outer wall of the upper end of the main housing and on both sides of an outer wall of the lower end of the main housing.

4. The 2-in-1 water flosser and electric toothbrush device according to claim 3, wherein an outer decorative cover protruding outward on all sides is arranged at the upper end of the main housing; the lower end of the outer decorative cover matches the upper end of the water tank and is configured to limit the water tank.

5. The 2-in-1 water flosser and electric toothbrush device according to claim 3, wherein a water filling port connected with the interior of the water tank is arranged on a side wall of the lower end of the water tank; a water filling cover is arranged at the water filling port; one side of the water filling cover is hinged to a buckle on the side wall of the water tank in a flip-open manner, and an inlet and outlet plug detachably clamped with the water filling port is arranged at the other side of the water filling cover.

6. The 2-in-1 water flosser and electric toothbrush device according to claim 3, wherein a main unit sealing ring is arranged between an outer peripheral wall of the bottom cover and an inner wall of the main housing; a water tank sealing ring is further arranged between the outer peripheral wall of the bottom cover and the inner wall of the water tank.

7. The 2-in-1 water flosser and electric toothbrush device according to claim 4, wherein the water flosser assembly comprises a water flosser pump arranged on one side inside the main housing; a water flosser circuit board electrically connected to the water flosser pump is installed on one side of the water flosser pump; a water flosser encapsulated display unit is arranged on the main housing located on the side of the water flosser circuit board; a water flosser switch is assembled on the water flosser encapsulated display unit at a position corresponding to the starting position of the water flosser circuit board;
a pump top ring is assembled on the top of the water flosser pump; a nozzle button is arranged inside the outer decorative cover above the pump top ring and passes through one side of the outer decorative cover in a depressible way; a nozzle is inserted into the insertion hole of the top cover; a clamping slot located on an outer wall of a bottom end of the nozzle forms a snap fit with the nozzle button; a pipe opening at the bottom end of the nozzle forms a sealed plug-in connection with the inner wall of the pump top ring; the bottom end of the nozzle is further connected to the water flosser pump;
a through column respectively connected with the main housing and the water tank is arranged inside the bottom cover; one end of a pump connecting pipe is connected to one side of the water flosser pump, and the other end of the pump connecting pipe is sleeved over the top of the through column of the bottom cover; one end of a water tank suction pipe is sleeved over the bottom of the through column, and the other end of the water tank suction pipe extends into the water tank; the water flosser pump is capable of drawing water from the water tank through the pump connecting pipe and the water tank suction pipe, and delivering water to the nozzle; the water tank suction pipe is flexible.

8. The 2-in-1 water flosser and electric toothbrush device according to claim 7, wherein a return spring is arranged between the nozzle button and the main housing, and two ends of the return spring elastically abut against the nozzle button and the inner wall of the main housing.

9. The 2-in-1 water flosser and electric toothbrush device according to claim 1, wherein the electric toothbrush assembly comprises a toothbrush movement arranged on the other side inside the main housing; an electric toothbrush circuit board is installed on one side of the top of the toothbrush movement; a toothbrush switch is assembled on the main housing at a position corresponding to the starting position of the electric toothbrush circuit board;
a sonic motor is assembled on the top of the toothbrush movement and is electrically connected to the electric toothbrush circuit board; an upper motor damping rubber, a motor fixing ring and a waterproof motor cover are sequentially arranged between the sonic motor and the top cover from bottom to top; the waterproof motor cover passes through the shaft-through hole of the top cover; a swing shaft is drivingly connected to the top of the sonic motor, passes through the upper motor damping rubber, the motor fixing ring and the waterproof motor cover, and extends above the top cover; a detachable toothbrush head is sleeved over the top of the swing shaft;
a battery serving as a power supply is assembled inside the toothbrush movement.

10. The 2-in-1 water flosser and electric toothbrush device according to claim 9, wherein a soft rubber pad is further arranged between the sonic motor and the electric toothbrush circuit board.

11. The 2-in-1 water flosser and electric toothbrush device according to claim 9, wherein a charging interface electrically connected to the battery is further assembled on the surface of the main housing;
a detachable flexible charging plug is further arranged at the charging interface, and a plug strip rotatably inserted into a jack socket of the main housing is arranged on one side of the charging plug.
